(19) United States
(12) Patent Application Publication
(10) Pub. No.: US 2025/0305487 A1
(43) Pub. Date: Oct. 2, 2025

(54) ELECTROACTIVE-GEL-BASED SHAPE TRANSFORMATION MODULE AND ASSEMBLY

(71) Applicant: SEOUL NATIONAL UNIVERSITY R&DB FOUNDATION, Seoul (KR)

(72) Inventors: Yong Hae HEO, Cheonan-si (KR); Yuk Gwon SONG, Cheonan-si (KR); Su Jin LIM, Seoul (KR); Ji Soo HA, Seoul (KR); Sang Youn KIM, Seoul (KR)

(73) Assignee: SEOUL NATIONAL UNIVERSITY R&DB FOUNDATION, Seoul (KR)

(21) Appl. No.: 19/089,329

(22) Filed: Mar. 25, 2025

(30) Foreign Application Priority Data
Mar. 26, 2024 (KR) 10-2024-0041316

(51) Int. Cl. F03G 7/00

(52) U.S. Cl. CPC F03G 7/0121

(57) ABSTRACT

An electroactive-gel-based shape transformation module according to the present invention may include an electroactive gel having a predetermined height, a first electrode disposed to adjoin one side of the electroactive gel, a second electrode disposed to adjoin the other side of the electroactive gel, a module housing having therein an accommodation region that accommodates a part of the electroactive gel, the first electrode, and the second electrode, and a flexible film having a lower surface supported by an upper portion of the electroactive gel.

### CROSS-REFERENCE TO RELATED APPLICATIONS

This application claims priority to and the benefit of Korean Patent Application No. 10-2024-0041316 filed in the Korean Intellectual Property Office on Mar. 26, 2024, the entire contents of which are incorporated herein by reference.

### TECHNICAL FIELD

The present invention relates to an electroactive-gel-based shape transformation module and assembly, and more particularly, to an electroactive-gel-based shape transformation module and assembly, in which first and second electrodes are respectively disposed at one side and the other side of an electroactive gel for supporting a lower portion of a flexible film, and a voltage is applied between the first and second electrodes to curve the electroactive gel toward one of the first and second electrodes that is a positive electrode, such that a height of the electroactive gel may be decreased, and a shape of the flexible film may be variously transformed.

### BACKGROUND ART

Recently, most touch interface devices have provided tactile feedback to provide various vivid sensations.

The tactile feedback in the related art has been mostly vibration stimulation using a vibration actuator. However, recently, studies have been actively conducted on technologies for providing various textures to enhance user experience.

For example, the methods of expressing texture in the related art include various methods including a method of providing different types of friction in accordance with a motion of a finger by changing a frictional force of a touch surface by using ultrasonic vibration, a method of providing friction by arranging piezoelectric element actuators in a matrix shape and changing a frictional force between a finger and a vibration surface, a method of providing stimulation by using a suction force of air, a method of providing electrical stimulation, and a method of providing cold and warm sensations by using a difference in temperature.

However, the method of expressing texture in the related art requires a device having a large and complicated configuration, and the method is rarely applied to portable devices.

Therefore, recently, there has been introduced a technology for expressing tactility or texture by using electroactive polymer.

The electroactive polymer is a material that may reproducibly exhibit expansion, contraction, curved phenomenon, and the like by means of electrical stimulation. Because the electroactive polymer has a high response speed and a wide operation frequency range, the electroactive polymer has recently attracted attention in the fields of tactile actuators, artificial muscles, artificial hearts, smart skin, ultra-precision machines, and the like.

### SUMMARY OF THE INVENTION

The present invention has been made in an effort to solve the above-described problems, and an object of the present invention is to provide an electroactive-gel-based shape transformation module and assembly, in which first and second electrodes are respectively disposed at one side and the other side of an electroactive gel for supporting a lower portion of a flexible film, and a voltage is applied between the first and second electrodes to curve the electroactive gel toward one of the first and second electrodes that is a positive electrode, such that a height of the electroactive gel may be decreased, and a shape of the flexible film may be variously transformed.

An electroactive-gel-based shape transformation module according to the present invention may include an electroactive gel having a predetermined height, a first electrode disposed to adjoin one side of the electroactive gel, a second electrode disposed to adjoin the other side of the electroactive gel, a module housing having therein an accommodation region that accommodates a part of the electroactive gel, the first electrode, and the second electrode, and a flexible film having a lower surface supported by an upper portion of the electroactive gel.

The electroactive-gel-based shape transformation module according to the present invention may further include: a power source configured to apply a voltage between the first electrode and the second electrode, in which a height of the electroactive gel is decreased as the upper portion of the electroactive gel is curved toward the electrode, which is a positive electrode between the first electrode and the second electrode, when a voltage is electrode and the second applied between the first electrode.

The flexible film may be lowered as the upper portion of the electroactive gel is curved toward the electrode, which is a positive electrode between the first electrode and the second electrode, and a height of the electroactive gel is decreased when a voltage is applied between the first electrode and the second electrode.

An electroactive-gel-based shape transformation assembly according to the present invention may include: a plurality of electroactive-gel-based shape transformation modules; an assembly housing having therein a plurality of accommodation regions configured to each accommodate a part of each of the plurality of electroactive-gel-based shape transformation modules; and a flexible film having a lower surface supported by the plurality of electroactive-gel-based shape transformation modules.

Each of the plurality of electroactive-gel-based shape transformation modules may include: an electroactive gel having a predetermined height; a first electrode disposed to adjoin one side of the electroactive gel; and a second electrode disposed to adjoin the other side of the electroactive gel.

A part of the electroactive gel, the first electrode, and the second electrode of any one electroactive-gel-based shape transformation module may be accommodated in each of the plurality of accommodation regions of the assembly housing.

The lower surface of the flexible film may be supported by the electroactive gel of each of the plurality of electroactive-gel-based shape transformation modules.

The electroactive-gel-based shape transformation assembly according to the present invention may further include: a power source configured to apply a voltage between the first electrode and the second electrode included in one or more electroactive-gel-based shape transformation modules among the plurality of electroactive-gel-based shape transformation modules, in which a height of the electroactive gel is decreased as an upper portion of the electroactive gel is curved toward the electrode, which is a positive electrode between the first electrode and the second electrode, when a voltage is applied between the first electrode and the second electrode.

Because a height of the flexible film may be decreased as the electroactive gel, which adjoins the first and second electrodes and to which a voltage is applied among the plurality of electroactive gels, is curved toward the electrode that is a positive electrode, only a region supported by the curved electroactive gel may be lowered.

According to one aspect of the present invention, the first and second electrodes are respectively disposed at one side and the other side of the electroactive gel for supporting the lower portion of the flexible film, and a voltage is applied between the first and second electrodes to curve the electroactive gel toward one of the first and second electrodes that is the positive electrode, such that the height of the electroactive gel may be decreased, and the shape of the flexible film may be variously transformed.

### BRIEF DESCRIPTION OF THE DRAWINGS

FIG. 1 is a perspective view of an electroactive-gel-based shape transformation module according to an embodiment of the present invention.

FIG. 2 is an exploded perspective view of the electroactive-gel-based shape transformation module according to the embodiment of the present invention.

FIG. 3A is a cross-sectional view illustrating a case in which no voltage is applied to first and second electrodes of the electroactive-gel-based shape transformation module according to the embodiment of the present invention.

FIG. 3B is a cross-sectional view illustrating a case in which a voltage is applied to the first and second electrodes of the electroactive-gel-based shape transformation module according to the embodiment of the present invention.

FIG. 4 is a perspective view of an electroactive-gel-based shape transformation assembly according to the embodiment of the present invention.

FIG. 5 is a perspective view illustrating a state in which a flexible film of the electroactive-gel-based shape transformation assembly according to the embodiment of the present invention is separated.

FIG. 6A is a cross-sectional view illustrating a case in which no voltage is applied to the first and second electrodes of all the shape transformation modules included in the electroactive-gel-based shape transformation assembly according to the embodiment of the present invention.

FIG. 6B is a cross-sectional view illustrating a case in which a voltage is applied to the first and second electrodes of some of the shape transformation modules included in the electroactive-gel-based shape transformation assembly according to the embodiment of the present invention.

FIG. 7A is a cross-sectional view illustrating a case in which no voltage is applied to first and second electrodes of all shape transformation modules included in an electroactive-gel-based transformation assembly according to another embodiment of the present invention.

FIG. 7B is a cross-sectional view illustrating a case in which a voltage is applied to the first and second electrodes of some of the shape transformation modules included in the electroactive-gel-based shape transformation assembly according to another embodiment of the present invention.

FIG. 8A is a cross-sectional view illustrating a case in which no voltage is applied to first and second electrodes of all shape transformation modules included in an electroactive-gel-based shape transformation assembly according to still another embodiment of the present invention.

FIG. 8B is a cross-sectional view illustrating a case in which a voltage is applied to the first and second electrodes of some of the shape transformation modules included in the electroactive-gel-based shape transformation assembly according to still another embodiment of the present invention.

### DETAILED DESCRIPTION

Hereinafter, exemplary embodiments are proposed to help understand the present invention. However, the following embodiments are provided just for more easily understanding the present invention, and the contents of the present invention are not limited by the embodiments.

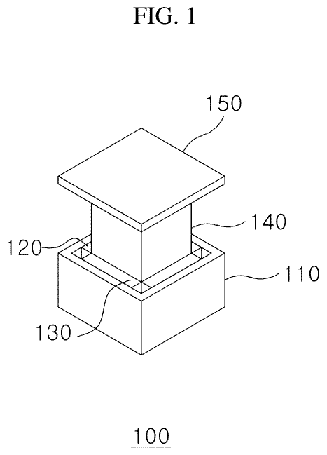

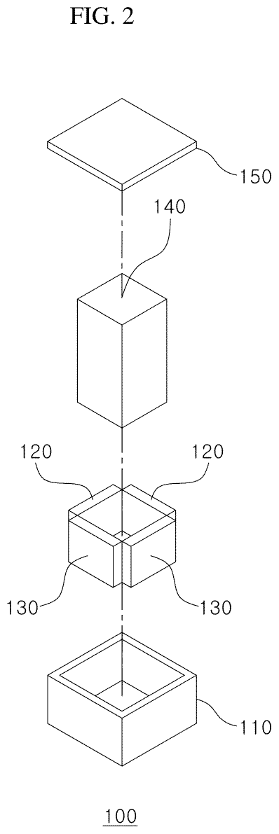

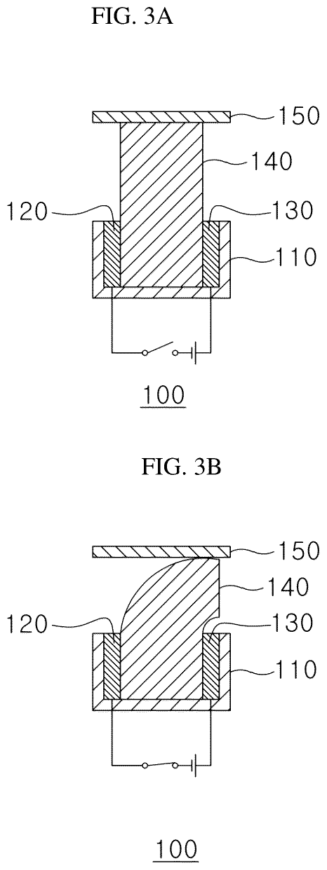

FIG. 1 is a perspective view of an electroactive-gel-based shape transformation module according to an embodiment of the present invention, FIG. 2 is an exploded perspective view of the electroactive-gel-based shape transformation module according to the embodiment of the present invention, FIG. 3A is a cross-sectional view illustrating a case in which no voltage is applied to first and second electrodes of the electroactive-gel-based shape transformation module according to the embodiment of the present invention, and FIG. 3B is a cross-sectional view illustrating a case in which a voltage is applied to the first and second electrodes of the electroactive-gel-based shape transformation module according to the embodiment of the present invention.

With reference to FIGS. 1 to 3B, an electroactive-gel-based shape transformation module 100 (hereinafter, referred to as a ‘shape transformation module’) according to an embodiment of the present invention may include a module housing 110, a first electrode 120, a second electrode 130, an electroactive gel 140, and a flexible film 150.

An accommodation region may be formed inside the module housing 110 and accommodate a part of the electroactive gel 140, the first electrode 120, and the second electrode 130.

In this case, the first electrode 120 and the second electrode 130 may be accommodated in the accommodation region of the module housing 110 in a state in which the first electrode 120 and the second electrode 130 adjoin two opposite sides of the electroactive gel 140.

Specifically, the first electrode 120 may be disposed to adjoin one side of the electroactive gel 140, and the second electrode 130 may be disposed to adjoin the other side of the electroactive gel 140.

In this case, the electroactive gel 140 may be a material having a gel shape including a plasticizer flowing between a polymer chain and a polymer chain and have a rectangular parallelepiped shape having a predetermined height.

Among the side surfaces of the electroactive gel 140, the first electrode 120 may be disposed to adjoin a first side surface at one side, and the second electrode 130 may be disposed to adjoin a second side surface at the other side positioned at the opposite side to the first side surface while facing the first side surface.

In addition, among the side surfaces of the electroactive gel 140, another first electrode 120 may be disposed to adjoin a third side surface at another side between the first side surface and the second side surface, and another second electrode 130 may be disposed to adjoin a fourth side surface at another side positioned between the first side surface and the second side surface and positioned at the opposite side to the third side surface while facing the third side surface.

In this case, the first electrode 120 and the second electrode 130 may be disposed to adjoin a lower portion of the side surface of the electroactive gel 140.

Meanwhile, as described above, a part of the electroactive gel 140, the first electrode 120, and the second electrode 130 are accommodated in the accommodation region of the module housing 110, the entire first electrode 120 and the entire second electrode 130 are accommodated in the accommodation region so that the first electrode 120 and the second electrode 130 are not disposed outside the accommodation region, and the electroactive gel 140 may be accommodated only up to a height at which the electroactive gel 140 adjoins the first electrode 120 and the second electrode 130.

Therefore, a portion of the electroactive gel 140, which does not adjoin the first electrode 120 and the second electrode 130, may be disposed in a region other than the accommodation region.

Hereinafter, a region of the electroactive gel 140 from a lowermost end thereof to the height at which the electroactive gel 140 adjoins the first electrode 120 and the second electrode 130 will be referred to as a first gel region, and a region other than the first gel region will be referred to as a second gel region.

Meanwhile, the first electrode 120 and the second electrode 130 may be formed in quadrangular plate shapes and disposed such that one large surface adjoins the side surface of the electroactive gel 140.

That is, the first gel region of the electroactive gel 140 may be surrounded by the first and second electrodes 120 and 130 having quadrangular plate shapes, and the first gel region of the electroactive gel 140 and the first and second electrodes 120 and 130 may be accommodated in the accommodation region of the module housing 110.

Meanwhile, the shape transformation module 100 may further include a power source electrically connected to the first electrode 120 and the second electrode 130 and configured to apply a voltage between the first electrode 120 and the second electrode 130. The power source may include a voltage source, a circuit configured to electrically connect the first electrode 120 and the second electrode 130 to the voltage source, and a switch configured to allow or block electrical conduction to the circuit.

The first electrode 120 may be a negative electrode, and the second electrode 130 may be a positive electrode. An upper portion of the electroactive gel 140 may adjoin a lower surface of the flexible film 150 and support the flexible film 150 from below.

A material of the electroactive gel 140 may be electroactive polymer (EAP). As an example of the electroactive polymer (EAP), the electroactive gel 140 may be an nPVC gel.

The nPVC gel includes a PVC chain and a dibutyl adipate (DBA) plasticizer. Pure PVC is made plastic by dibutyl adipate (DBA). The dibutyl adipate (DBA) increases a free volume of the PVC chain and decreases an attractive force between molecules of the PVC chain.

As illustrated in FIG. 3A, when no external voltage is applied to the electroactive gel 140, i.e., the nPVC gel, that is, when no voltage is applied between the first electrode 120 and the second electrode 130 disposed to adjoin the electroactive gel 140, dibutyl adipate (DBA) molecules present in the nPVC gel may move irregularly, and the shape of the electroactive gel 140 having flexibility may not be transformed.

On the contrary, as illustrated in FIG. 3B, when an external voltage is applied to the electroactive gel 140, i.e., the nPVC gel, that is, when a voltage is applied between the first electrode 120 and the second electrode 130 disposed to adjoin the electroactive gel 140, the dibutyl adipate (DBA) molecules may move toward the second electrode 130 that is the positive electrode between the first electrode 120 and the second electrode 130, and the dibutyl adipate (DBA) molecules may affect the molecule motions of the PVC chain.

Therefore, the electroactive gel 140, i.e., the nPVC gel may be transformed while being curved in a direction toward the second electrode 130 that is the positive electrode.

For this reason, a height of the electroactive gel 140 may be reduced when the electroactive gel 140 is transformed while being curved in the direction toward the second electrode 130, i.e., the positive electrode as the voltage is applied between the first electrode 120 and the second electrode 130.

Therefore, the flexible film 150, which has the lower portion supported by the upper portion of the electroactive gel 140, may be lowered by the reduced height of the electroactive gel 140.

In case that the power source repeatedly applies or does not apply the voltage, the electroactive gel 140 is repeatedly curved and straightened, such that the height may also be repeatedly increased and decreased.

As the height of the electroactive gel 140 is repeatedly increased or decreased, the flexible film 150, which has the lower portion supported by the upper portion of the electroactive gel 140, may be repeatedly raised and lowered.

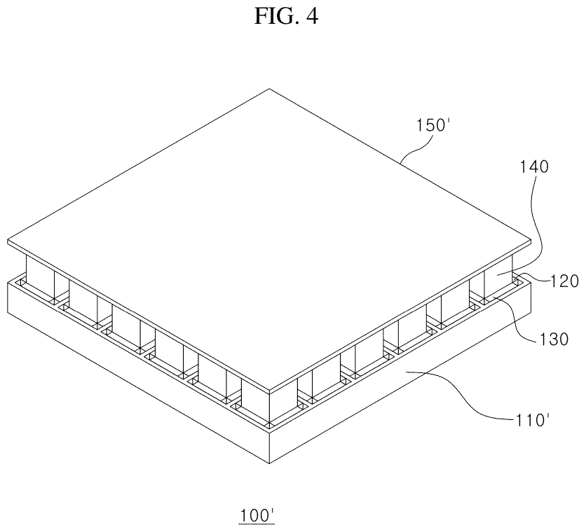

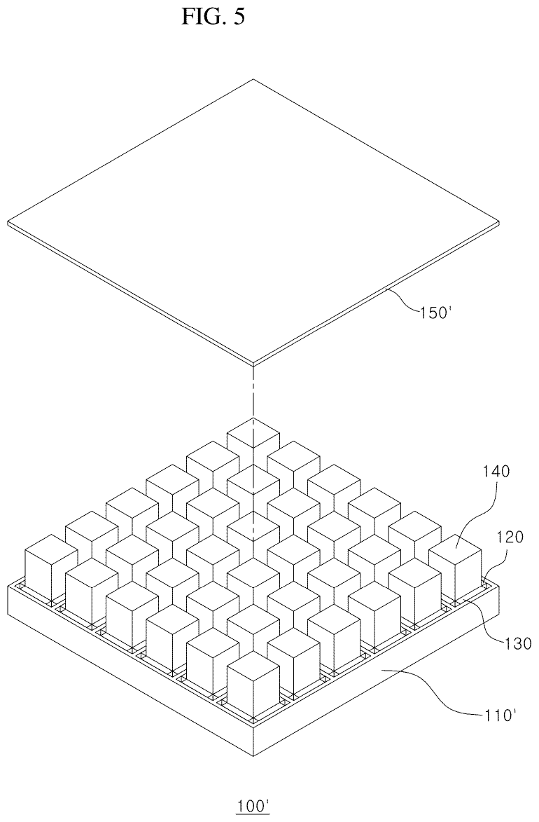

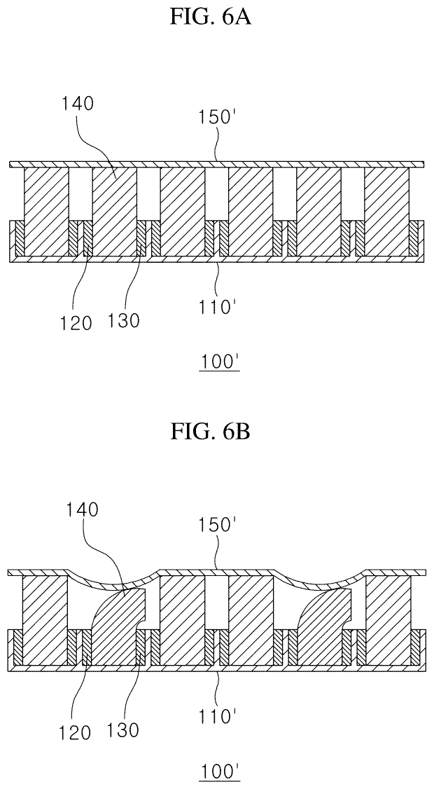

FIG. 4 is a perspective view of an electroactive-gel-based shape transformation assembly according to the embodiment of the present invention, FIG. 5 is perspective view illustrating a state in which a flexible film of the electroactive-gel-based shape transformation assembly according to the embodiment of the present invention is separated, FIG. 6A is a cross-sectional view illustrating a case in which no voltage is applied to the first and second electrodes of all the shape transformation modules included in the electroactive-gel-based shape transformation assembly according to the embodiment of the present invention, and FIG. 6B is a cross-sectional view illustrating a case in which a voltage is applied to the first and second electrodes of some of the shape transformation modules included in the electroactive-gel-based shape transformation assembly according to the embodiment of the present invention.

With reference to FIGS. 4 to 6B, an electroactive-gel-based shape transformation assembly 100′ (hereinafter, referred to as a ‘shape transformation assembly’) according to the embodiment of the present invention may include the plurality of shape transformation modules (100 in FIG. 1) and a controller.

In this case, like the above-mentioned shape transformation module (100 in FIG. 1), the plurality of shape transformation modules included in the shape transformation assembly 100′ may each also include the module housing 110, the first electrode 120, the second electrode 130, the electroactive gel 140, the flexible film 150, and the power source or include only the first electrode 120, the second electrode 130, the electroactive gel 140, and the power source, except for the module housing 110 and the flexible film 150.

Hereinafter, the shape transformation assembly 100′ including the plurality of shape transformation modules each including only the first electrode 120, the second electrode 130, the electroactive gel 140, and the power source without including the module housing 110 and the flexible film 150 will be described.

In summary, the shape transformation assembly 100′ may include the plurality of shape transformation modules including only the first electrode 120, the second electrode 130, the electroactive gel 140, and the power source and include assembly housings 110′ configured to accommodate the plurality of shape transformation modules, and one flexible film 150′ configured to be supported by the electroactive gels 140 respectively included in the plurality of shape transformation modules.

The assembly may be provided as a plurality of assembly housings 110′ formed inside accommodation spaces respectively configured to accommodate the plurality of shape transformation modules.

The accommodation region formed inside the assembly housing 110′ may also accommodate a part of the electroactive gel 140 and the first and second electrodes 120 and 130 of each of the plurality of shape transformation modules.

Specifically, the plurality of shape transformation modules included in the shape transformation assembly 100′ may each be accommodated in the first gel region of the electroactive gel 140, and the first and second electrodes 120 and 130 may be accommodated in each of the plurality of accommodation regions.

The flexible film 150′ included in the shape transformation assembly 100′ is similar to the flexible film 150 included in the shape transformation module (100 in FIG. 1). However, the flexible film 150′ included in the shape transformation assembly 100′ is not supported as the lower surface thereof adjoins only the upper portion of any one electroactive gel 140, but the flexible film 150′ may be supported as the lower surface thereof adjoins the upper portions of the electroactive gels 140 of all the shape transformation modules included in the shape transformation assembly 100′.

In this case, the controller may control the power source of each of the plurality of shape transformation modules in order to apply or not to apply a voltage between the first electrode 120 and the second electrode 130 of each of the plurality of shape transformation modules.

For example, the controller may control the power source of the corresponding shape transformation module so that a voltage is applied between the first and second electrodes 120 and 130 of some of the plurality of shape transformation modules.

Therefore, a region of the flexible film 150′, which is supported by the electroactive gel 140 positioned between the first and second electrodes 120 and 130 to which the voltage is applied, may be concavely recessed downward.

To this end, the flexible film 150′ may be made of a material that is transformable in shape and has flexibility.

That is, a region of the flexible film 150′, which is supported by the electroactive gel 140 positioned between the first and second electrodes 120 and 130 to which no voltage is applied, is supported flat because the electroactive gel 140, which supports the flexible film 150′ from below, is not curved, and the height thereof is not decreased. However, the region, which is supported by the electroactive gel 140 positioned between the first and second electrodes 120 and 130 to which the voltage is applied, may be concavely recessed because the electroactive gel 140, which supports the flexible film 150′ from below, is curved, and the height thereof is decreased.

With the use of this configuration, in response to a user's signal or various control signals, the controller may control the power source of the corresponding shape transformation module so that a voltage is applied between the first and second electrodes 120 and 130 of some of the plurality of shape transformation modules so that a predetermined region of the flexible film 150′ is concavely recessed.

Therefore, the shape transformation assembly 100′ may provide the user with bumpy resistance as only the predetermined region (the upper portions of some of the shape transformation modules) of the flexible film 150′ is recessed.

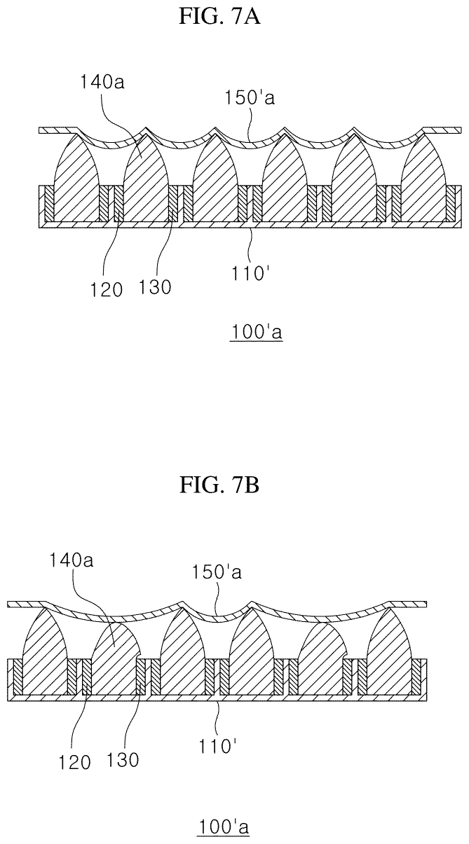

FIG. 7A is a cross-sectional view illustrating a case in which no voltage is applied to first and second electrodes of all shape transformation modules included in an electroactive-gel-based shape transformation assembly according to another embodiment of the present invention, and FIG. 7B is a cross-sectional view illustrating a case in which a voltage is applied to the first and second electrodes of some of the shape transformation modules included in the electroactive-gel-based shape transformation assembly according to another embodiment of the present invention.

With reference to FIGS. 7A-7B, an electroactive-gel-based shape transformation assembly 100′a (hereinafter, referred to as a ‘shape transformation assembly’) according to another embodiment of the present invention differs from the shape transformation assembly 100′ according to the embodiment of the present invention only in terms of an electroactive gel 140a included in each of the shape transformation modules but may include the same constituent elements as the shape transformation assembly 100′.

Specifically, the first gel region of the electroactive gel 140a of the transformation assembly 100′a according to another embodiment may be formed to have a cross-sectional area with a constant size from the lower portion to the upper portion thereof, but the second gel region may be formed in a shape having a cross-sectional area that decreases upward.

Therefore, the electroactive gel 140a of the transformation assembly 100′a according to another embodiment may be in point contact, instead of surface contact, with a flexible film 150′a disposed above the electroactive gel 140a.

Therefore, the flexible film 150′a of the transformation assembly 100′a according to another embodiment may be supported by the electroactive gel 140a while being in point contact with the electroactive gel 140a, such that a portion between the points supported by the electroactive gels 140a may be curved by being sagged downward. Therefore, the flexible film 150′a between the electroactive gels 140a may be concavely recessed.

In this case, the controller may control the power source of the corresponding shape transformation module so that a voltage is applied between the first and second electrodes 120 and 130 of some of the plurality of shape transformation modules.

Therefore, a region of the flexible film 150′a of the transformation assembly 100′a according to another embodiment, which is supported by the electroactive gel 140a positioned between the first and second electrodes 120 and 130 to which the voltage is applied, may be concavely recessed downward as the electroactive gel 140a is curved and decreases in height.

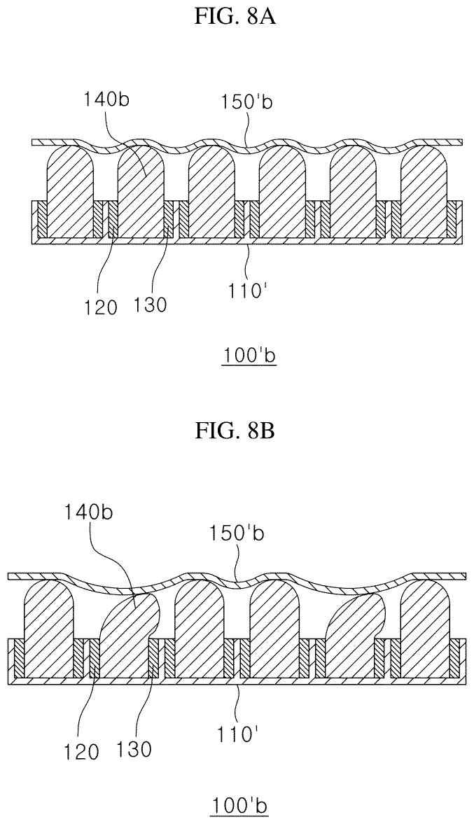

Therefore, a region of the flexible film 150′a of the transformation assembly 100′a according to another embodiment, which is not supported by the electroactive gel 140a, provides a concavely recessed shape, and the region supported by the electroactive gel 140a curved by the applied voltage may provide a more concavely recessed shape. FIG. 8A is a cross-sectional view illustrating a case in which no voltage is applied to first and second electrodes of all shape transformation modules included in an electroactive-gel-based shape transformation assembly according to still another embodiment of the present invention, and FIG. 8B is a cross-sectional view illustrating a case in which a voltage is applied to the first and second electrodes of some of the shape transformation modules included in the electroactive-gel-based shape transformation assembly according to still another embodiment of the present invention.

With reference to FIGS. 8A-8B, an electroactive-gel-based shape transformation assembly 100′b (hereinafter, referred to as a ‘shape transformation assembly’) according to still another embodiment of the present invention differs from the shape transformation assembly 100′ according to the embodiment of the present invention only in terms of an electroactive gel 140b included in each of the shape transformation modules but may include the same constituent elements as the shape transformation assembly 100′.

Specifically, the electroactive gel 140b of the transformation assembly 100′b according to still another embodiment may be formed in a shape made by coupling a hemispherical shape to an upper portion of a rectangular parallelepiped shape.

Therefore, the electroactive gel 140b of the transformation assembly 100′b according to still another embodiment may be in curved surface contact, instead of flat surface contact, with a flexible film 150′b disposed above the electroactive gel 140b.

Therefore, the flexible film 150′b of the transformation assembly 100′b according to still another embodiment may be supported by the electroactive gel 140b while being in curved surface contact with the electroactive gel 140b, such that a portion between the curved surfaces supported by the electroactive gels 140b may be curved by being sagged downward. Therefore, the flexible film 150′b between the electroactive gels 140b may be concavely recessed, and the flexible film 150′b supported by the electroactive gel 140b may maintain the shape of the curved surface.

In this case, the controller may control the power source of the corresponding shape transformation module so that a voltage is applied between the first and second electrodes 120 and 130 of some of the plurality of shape transformation modules.

Therefore, a region of the flexible film 150′b of the transformation assembly 100′b according to still another embodiment, which is supported by the electroactive gel 140b positioned between the first and second electrodes 120 and 130 to which the voltage is applied, may be concavely recessed downward as the electroactive gel 140b is curved and decreases in height.

Therefore, the region of the flexible film 150′b of the transformation assembly 100′b according to still another embodiment, which is not supported by the electroactive gel 140b, is concavely recessed, and the region supported by the electroactive gel 140b provides the shape for maintaining the shape of the curved surface, such that the region supported by the electroactive gel 140b curved by the applied voltage may provide a more concavely recessed shape.

While the present invention has been described above with reference to the exemplary embodiments, it may be understood by those skilled in the art that the present invention may be variously modified and changed without departing from the spirit and scope of the present invention disclosed in the claims.

What is claimed is:

1. An electroactive-gel-based shape transformation module comprising:
an electroactive gel having a predetermined height;
a first electrode disposed to adjoin one side of the electroactive gel;
a second electrode disposed to adjoin the other side of the electroactive gel;
a module housing having therein an accommodation region that accommodates a part of the electroactive gel, the first electrode, and the second electrode; and
a flexible film having a lower surface supported by an upper portion of the electroactive gel.

2. The electroactive-gel-based shape transformation module of claim 1, further comprising:
a power source configured to apply a voltage between the first electrode and the second electrode,
wherein a height of the electroactive gel is 41 decreased as the upper portion of the electroactive gel is curved toward the electrode, which is a positive electrode between the first electrode and the second electrode, when a voltage is applied between the first electrode and the second electrode.

3. The electroactive-gel-based shape transformation module of claim 1, wherein the flexible film is lowered as the upper portion of the electroactive gel is curved toward the electrode, which is a positive electrode between the first electrode and the second electrode, and a height of the electroactive gel is decreased when a voltage is applied between the first electrode and the second electrode.

4. An electroactive-gel-based shape transformation assembly comprising:
a plurality of electroactive-gel-based shape transformation modules;
an assembly housing having therein a plurality of accommodation regions configured to each accommodate a part of each of the plurality of electroactive-gel-based shape transformation modules; and
a flexible film having a lower surface supported by the plurality of electroactive-gel-based shape transformation modules.

5. The electroactive-gel-based shape transformation assembly of claim 4, wherein each of the plurality of electroactive-gel-based shape transformation modules comprises:
an electroactive gel having a predetermined height;
a first electrode disposed to adjoin one side of the electroactive gel; and
a second electrode disposed to adjoin the other side of the electroactive gel.

6. The electroactive-gel-based shape transformation assembly of claim 5, wherein a part of the electroactive gel, the first electrode, and the second electrode of any one electroactive-gel-based shape transformation module are accommodated in each of the plurality of accommodation regions of the assembly housing.

7. The electroactive-gel-based shape transformation assembly of claim 5, wherein the lower surface of the flexible film is supported by the electroactive gel of each of the plurality of electroactive-gel-based shape transformation modules.

8. The electroactive-gel-based shape transformation assembly of claim 6, further comprising:
a power source configured to apply a voltage between the first electrode and the second electrode included in one or more electroactive-gel-based shape transformation modules among the plurality of electroactive-gel-based shape transformation modules,
wherein a height of the electroactive gel is decreased as an upper portion of the electroactive gel is curved toward the electrode, which is a positive electrode between the first electrode and the second electrode, when a voltage is applied between the first electrode and the second electrode.

9. The electroactive-gel-based shape transformation assembly of claim 7, wherein a height of the flexible film is decreased as the electroactive gel, which adjoins the first and second electrodes and to which a voltage is applied among the plurality of electroactive gels, is curved toward the electrode that is a positive electrode, and only a region supported by the curved electroactive gel is lowered.
